(19) United States
(12) Patent Application Publication
(10) Pub. No.: US 2015/0240101 A1
(43) Pub. Date: Aug. 27, 2015

(54) HIGH SILVER CONTENT NANOSILVER INK FOR GRAVURE AND FLEXOGRAPHIC PRINTING APPLICATIONS

(71) Applicant: XEROX CORPORATION, Norwalk, CT (US)

(72) Inventors: Naveen Chopra, Oakville (CA); Ping Liu, MIssissauga (CA); Cuong Vong, Hamilton (CA); Sandra Gardner, Oakville (CA); Yiliang Wu, Oakville (CA); Mahya Mokhtari, Etobicoke (CA)

(73) Assignee: XEROX CORPORATION, NORWALK, CT (US)

(21) Appl. No.: 14/188,284

(22) Filed: Feb. 24, 2014

(51) Int. Cl. C09D 11/52; C09D 137/00; C09D 153/00; C09D 109/06; C09D 125/08; C09D 177/00; C09D 133/08; C09D 133/02; C09D 133/12; C09D 133/10; C09D 123/02; C09D 123/20; C08K 3/08; C09D 131/04

(52) U.S. Cl. CPC C09D 11/52; C08K 3/08; C09D 137/00; C09D 153/00; C09D 109/06; C09D 125/08; C09D 131/04; C09D 133/08; C09D 133/02; C09D 133/12; C09D 133/10; C09D 123/02; C09D 123/20; C09D 177/00; C08K 2003/0806

(57) ABSTRACT

A high silver content nanosilver conductive ink includes at least about 65% weight of silver nanoparticles, a non-polar organic solvent and, a polymer binder. The conductive ink has a has a conductivity of from about 1.0×10⁴ (S/cm) to about 4.0×10⁵ (S/cm). and a viscosity of from about 20 cps to about 1,000 cps.

### TECHNICAL FIELD

This disclosure is generally directed to conductive inks. More specifically, this disclosure is directed to conductive inks having a high silver content for gravure and flexographic printing, and methods for producing such conductive inks.

### BACKGROUND

Conventional conductive silver inks used for offset printing technology include silver particles, carrier solvent(s), and polymer binder(s). Gravure and flexography processes could be an efficient way to manufacture a number of conductive components with low cost. However, some of the main limitations with current gravure and flexography inks include poor conductivity and poor resolution.

It appears that these printing processes could be an efficient way to manufacture a number of conductive components with low cost. However, one of the main limitations with current gravure and flexography inks include poor conductivity and poor resolution.

The poor conductivity is generally due to poor contact among conductive silver particles in the printed films. In practice, this problem is addressed by increasing the thickness in the prints. However, this translates into more materials being deposited onto the substrate, which increases the cost and the need for more solvent as well. Increased solvent slows down the curing step and, as such, slows down the printing speed. Higher printing speed is an advantage of a roll-to-roll process when compared to batch printing such as screen printing.

Current conductive inks including high loading of silver nanoparticles of about 50-70% have a viscosity in the range of 8 to 12 cps. Such low viscosity is usually not sufficient for most gravure and flexographic printing processes, which often require a viscosity from about 20 to 1,000 cps.

In view of the above, current silver flake conductive inks have limited applications for printing high quality electronic circuits such as RFID antennas etc. where high conductivity is required.

There remains a need for conductive inks with high conductivity and good print resolution for gravure and flexographic printing processes.

### SUMMARY

The following detailed description is of the best currently contemplated modes of carrying out exemplary embodiments herein. The description is not to be taken in a limiting sense, but is made merely for the purpose of illustrating the general principles of the disclosure herein, since the scope of the disclosure herein is best defined by the appended claims.

Various inventive features are described below that can each be used independently of one another or in combination with other features.

Broadly, embodiments of the disclosure herein generally provide a high silver content nanosilver conductive ink including silver nanoparticles comprising an amount of at least about 65 weight percent of the ink, one or more non-polar organic solvents, and optionally a binder.

In another aspect of the disclosure herein, a high silver content nanosilver conductive ink includes silver nanoparticles comprising an amount of at least about 65 weight percent of the ink, one or more solvents, and optionally a binder, wherein the ink has a viscosity from about 20 to about 1000 cps.

In yet another aspect of the disclosure herein a high silver content nanosilver conductive ink includes silver nanoparticles comprising an amount of at least about 65 weight percent of the ink, a solvent, and a binder, wherein the ink has a sheet resistivity of less than about 2 Ω/sq.

### BRIEF DESCRIPTION OF THE FIGURES

Various embodiments of the present disclosure will be described herein below with reference to the following figures wherein:

FIG. 1 illustrates a scanning electron microscope image (SEM image) of the top view of a cured ink film of Example 1 deposited onto a coated paper substrate (sample A);

FIG. 2 illustrates an SEM cross-sectional view of the film of FIG. 1;

FIG. 3 illustrates an SEM image of the top view of a cured ink film of Example 1 deposited onto a Mylar substrate (sample B);

FIG. 4 illustrates an SEM cross-sectional side view of the film of FIG. 3;

FIG. 5 illustrates an SEM image of the top view of a cured ink film of Example 1 deposited onto a Mylar substrate (sample C);

FIG. 6 illustrates an SEM cross-sectional view of the film of FIG. 5;

FIG. 7 illustrates an SEM image of the top view of a cured ink film of Example 1 deposited onto a Mylar substrate (sample D); and

FIG. 8 illustrates an SEM cross-sectional view of the film of FIG. 7.

### DETAILED DESCRIPTION

In the present disclosure, the terms “a,” “an,” and “the” include plural forms unless the content clearly dictates otherwise.

In the present disclosure, ranges disclosed herein include, unless specifically indicated, all endpoints and intermediate values.

In the present disclosure, the term “optional” or “optionally” refer, for example, to instances in which subsequently described circumstances may or may not occur, and include instances in which the circumstance occurs and instances in which the circumstance does not occur.

In the present disclosure, the phrases “one or more” and “at least one” refer, for example, to instances in which one of the subsequently described circumstances occurs, and to instances in which more than one of the subsequently described circumstances occurs.

In the present disclosure, the term “about” used in connection with a quantity is inclusive of the stated value and has the meaning dictated by the context (for example, it includes at least the degree of error associated with the measurement of the particular quantity). When used in the context of a range, the term “about” should also be considered as disclosing the range defined by the absolute values of the two endpoints. For example, the range “from about 2 to about 4” also discloses the range “from 2 to 4.”

In the present invention, the term “nano” as used in “silver nanoparticles” refers to, for example, a particle size of less than about 100 nm, for example, from about 0.5 nm to about 100 nm, or from about 1 nm to about 50 nm, or from about 1 nm to about 20 nm. The particle size refers to the average diameter of the metal particles, as determined by transmission electron microscopy (TEM) or other suitable method.

In the present disclosure, the term “printing” refers to any coating technique capable of forming a conductive ink paste composition into a desired pattern a substrate. Examples of suitable techniques include, for example, spin coating, blade coating, rod coating, dip coating, lithography or offset printing, gravure, flexography, screen printing, stencil printing, and stamping (such as microcontact printing).

The present disclosure generally provides a conductive ink including silver nanoparticles present in an amount of at least about 65 weight percent of the ink, a non-polar solvent(s), and a binder. The present disclosure also provides methods for producing such conductive inks.

The conductive ink herein may be made by any suitable method. One exemplary method is to disperse the silver nanoparticles into a non-polar organic solvent and optionally the polymeric binder under inert bubbling. Then, the organic solvent can be removed by heating and the resulting ink shaken and rolled to ensure mixing.

The conductive ink can be used to form conductive features on a substrate by printing. The printing may be carried out by depositing the ink on a substrate using any suitable printing technique, for example, gravure, rotogravure, flexography, lithography, etching, or screen printing.

The substrate upon which the conductive ink is deposited may be any suitable substrate including, for example, silicon, glass plate, plastic film, sheet, fabric, or paper. For structurally flexible devices, plastic substrates such as polyester, polycarbonate, polyimide sheets and the like may be used.

Following printing, the patterned deposited conductive ink can be subjected to a curing step. The curing step can be a step in which substantially all of the solvent of the conductive ink is removed and the ink is firmly adhered to the substrate.

Annealing the silver ink to the substrate may be done by any suitable means in the art. In an exemplary embodiment, the substrate is heated at a temperature in the range of about 50° C. to about 300° C. In another exemplary embodiment, the substrate is heated at a temperature in the range of about 100° C. to 250° C. The substrate is heated over a time period in the range of about 10 to about 30 minutes.

The printing and annealing steps may be generally performed in an ambient environment. Generally, an ambient environment refers to a normal atmospheric air environment, not requiring the presence of an inert gas environment. In addition, the printing and annealing steps can be performed simultaneously or consecutively.

### Silver Nanoparticles

According to embodiments herein, the silver nanoparticles can have a diameter in the submicron range. Silver nanoparticles herein can have unique properties when compared to silver flakes. For example, the silver nanoparticles herein can be characterized by enhanced reactivity of the surface atoms, high electric conductivity, and unique optical properties. Further, the silver nanoparticles can have a lower melting point and a lower sintering temperature than silver flakes.

Due to their small size, silver nanoparticles exhibit a melting point as low as 700° C. below the silver flakes. For example, silver nanoparticles may sinter at 120° C. which is more than 800° C. below the melting temperature of bulk silver. This lower melting point is a result of comparatively high surface-area-to-volume ratio in nanoparticles, which allows bonds to readily form between neighboring particles. The large reduction in sintering temperature for nanoparticles enables forming highly conductive traces or patterns on flexible plastic substrates, because the flexible substrates of choice melt or soften at relatively low temperature (for example, 150° C.).

The silver nanoparticles herein may be elemental silver, a silver alloy, a silver compound, or combination thereof. In embodiments, the silver nanoparticles may be a base material coated or plated with pure silver, a silver alloy, or a silver compound. For example, the base material may be cooper flakes with silver plating.

Examples of useful silver compounds include silver oxide, silver thiocyanate, silver cyanide, silver cyanate, silver carbonate, silver nitrate, silver nitrite, silver sulfate, silver phosphate, silver perchlorate, silver tetrafluoroborate, silver acetylacetonate, silver acetate, silver lactate, silver oxalate and derivatives thereof. The silver alloy may be formed from at least one metal selected from Au, Cu, Ni, Co, Pd, Pt, Ti, V, Mn, Fe, Cr, Zr, Nb, Mo, W, Ru, Cd, Ta, Re, Os, Ir, Al, Ga, Ge, In, Sn, Sb, Pb, Bi, Si, As, Hg, Sm, Eu, Th Mg, Ca, Sr and Ba, but not particularly limited to them.

In embodiments, the silver compound may include either or both of (i) one or more other metals and (ii) one or more non-metals. Suitable other metals include, for example, Al, Au, Pt, Pd, Cu, Co, Cr, In, and Ni, particularly the transition metals, for example, Au, Pt, Pd, Cu, Cr, Ni, and mixtures thereof. Exemplary metal composites are Au—Ag, Ag—Cu, Au—Ag—Cu, and Au—Ag—Pd. Suitable non-metals in the metal composite include, for example, Si, C, and Ge.

In embodiments, the silver nanoparticles are composed of elemental silver.

The silver nanoparticles herein may have an average particle size, for example, from about 0.5 to about 100.0 nm, or from about 1.0 to about 50.0 nm, or from about 1.0 to about 20.0 nm.

The use of nano-sized silver nanoparticles can result in thin and uniform films with high conductivity and low surface roughness, which is important for multilayer electronic device integration.

The silver nanoparticles may have any shape or geometry. In certain embodiments, the silver nanoparticles may have a spherical shape.

The silver nanoparticles may be present in the conductive ink in an amount, for example, of at least about 65 weight percent, or from about 50 to about 95 weight percent, or from about 60 to about 90 weight percent of the conductive ink.

In embodiments, the silver nanoparticles have a stability (that is, the time period where there is minimal precipitation or aggregation of the nanoparticles) of, for example, at least about 1 day, or from about 3 days to about 1 week, or from about 5 days to about 1 month, or from about 1 week to about 6 months, or from about 1 week to over 1 year.

### Solvent(s)

The conductive ink herein may also include a solvent(s), such as a non-polar organic solvent(s). The solvent may be used as a vehicle for dispersion of the silver nanoparticles to minimize or prevent the silver nanoparticles from agglomerating and/or optionally providing or enhancing the solubility or dispersiblity of silver nanoparticles.

Suitable non-polar organic solvents for silver nanoparticle conductive inks herein include, for example, hydrocarbons such as an alkane; an alkene; an alcohol having from about 10 to about 18 carbon atoms such as, undecane, dodecane, tridecane, tetradecane, hexadecane, 1-undecanol, 2-undecanol, 3-undecanol, 4-undecanol, 5-undecanol, 6-undecanol, 1-dodecanol, 2-dodecanol, 3-dodecanol, 4-dodecanol, 5-dodecanol, 6-dodecanol, 1-tridecanol, 2-tridecanol, 3-tridecanol, 4-tridecanol, 5-tridecanol, 6-tridecanol, 7-tridecanol, 1-tetradecanol, 2-tetradecanol, 3-tetradecanol, 4-tetradecanol, 5-tetradecanol, 6-tetradecanol, 7-tetradecanol, and the like; an alcohol, such as for example, terpineol (α-terpineol), β-terpineol, geraniol, cineol, cedral, linalool, 4-terpineol, lavandulol, citronellol, nerol, methol, borneol, hexanol heptanol, cyclohexanol, 3,7-dimethylocta-2,6-dien-1ol, 2-(2-propyl)-5-methyl-cyclohexane-1-ol; isoparaffinic hydrocarbons such as, for example, isodecane, isododecane; commercially available mixtures of isoparaffins such as ISOPAR E®, ISOPAR C®, ISOPAR H®, ISOPAR L®, ISOPAR V®, ISOPAR M® all manufactured by Exxon Chemical Company; SHELLSOL® manufactured by Shell Chemical Company; SOLTROL® manufactured by Philips Oil Co., Ltd.; BEGASOL® manufactured by Mobil Petroleum Co., Inc.; IP Solvent 2835 made by Idemitsu Petrochemical Co., Ltd; naphthenic oils; aromatic solvents such as benzene; nitrobenzene; toluene; ortho-, meta-, and para-xylene, and mixtures thereof; 1,3,5-trimethylbenzene (mesitylene); 1,2-, 1,3- and 1,4-dichlorobenzene and mixtures thereof; trichlorobenzene; cyanobenzene; phenylcyclohexane and tetralin; aliphatic solvents (such as: hexane; heptane; octane; isooctane; nonane; decane; dodecane); cyclic aliphatic solvents (such as: bicyclohexyl and decalin).

In embodiments, two or more non-polar organic solvents may be used.

The non-polar organic solvent(s) may be present in the conductive ink in an amount, for example, from about 5.0 to about 50.0 weight percent, or from about 10.0 to about 40.0 weight percent, or from about 10.0 to about 30.0 weight percent of the conductive ink.

### Binder(s)

The conductive ink may optionally include a binder(s), such as polymer binder(s). The binder(s) may act as an adhesion promoter to facilitate the adhesion of the conductive ink to a wide variety of substrates and also to increase the stability of ink, such as by extending the shelf life of the ink.

The binder(s), such as polymer binder(s), may have a high viscosity (>10⁶ cps at room temperatures) to allow the ink to retain the pattern following printing.

The binder(s) may have a weight average molecular weight (Mw) of about 10,000 to about 600,000 Da, or from about 40,000 to about 300,000 Da, or from about 40,000 to about 250,000 Da.

The binder(s) may be present in an amount of from about 0.25 to about 10 weight percent, or from about 0.5 to about 5 weight percent, or from about 1 to about 2.5 weight percent of the conductive ink.

The polymer binder(s) may be, for example, a polyvinylbutyral (PVB) terpolymer; polyesters such as terephthalates, terpenes, styrene block; copolymers such as styrene-butadiene-styrene copolymer, styrene-isoprene-styrene copolymer, styrene-ethylene/butylene-styrene copolymer, and styrene-ethylene/propylene copolymer; ethylene-vinyl acetate copolymers; ethylene-vinyl acetate-maleic anhydride terpolymers; ethylene butyl acrylate copolymer; ethylene-acrylic acid copolymer; polymethylmethacrylate; polyethylmethacrylate; poly(alkyl)methacrylates; polyolefins; polybutene, polyamides; and mixtures thereof.

In embodiments, the polymer binder is a PVB terpolymer. Examples of useful PVB terpolymers include, for example, polymers manufactured by MOWITAL® (Kuraray America), S-LEC® (Sekisui Chemical Company), BUTVAR® (Solutia).

The ink herein may have a viscosity of from about 20 cps to about 1,000 cps, or from about 30 cps to about 750 cps, or from about 40 cps to about 500 cps. The inks herein may have a conductivity of from about 1.0×10⁴ S/cm to about 4.0×10⁵ S/cm, or from about 1.5×10⁴ S/cm to about 3.5×10⁵ S/cm, or from about 2×10⁴ S/cm to about 3×10⁵ S/cm. In embodiments, the inks herein can have a conductivity of about 3.5×10⁴S/cm

### EXAMPLE

The following Example illustrates one exemplary embodiment of the present disclosure. This Example is intended to be illustrative only to show one of several methods of preparing the conductive ink and is not intended to limit the scope of the present disclosure. Also, parts and percentages are by weight unless otherwise indicated.

In this Example, a sample ink was prepared using silver nanoparticles, and a mixture of non-polar organic solvents, The sample ink had the composition described in Table 1.

TABLE 1

| | Wt (%) | Wt |
|---|---|---|
| Silver nanoparticle | 82 | 24.6 |
| Bicyclohexyl | 3.6 | 1.08 |
| Decalin | 14.4 | 4.32 |
| TOTAL | 100 | 30.0 |

### Example 1

### Ink Preparation

To a 30 mL plastic bottle was added 24.6 g nanosilver (a solid dispersion containing 90 wt % nanosilver particles in decalin solvent), followed by 4.32 g decalin solvent and 0.62 g of bicyclohexyl (7:1 ratio decalin/bicyclohexyl). Then, 10 g of 6 mm diameter glass beads were added, and the sample was purged with Ar, the bottle was sealed with tape, and roll-milled at 175 rpm for 4 hours. Next, the sample was weighed, then bubbled with Ar via a 16 ga. s/s syringe needle to remove volatile solvents remaining from the nanoparticle synthesis overnight. The next day, the sample was reweighed, and the mass of solvent lost was calculated. After accounting for the 12% volatiles content (determined TGA analysis), decalin and bicyclohexyl solvents were back-added to meet the 7:1 ratio of decalin/bicyclohexyl to the mixture. Finally, the sample was re-milled for 1 hour at 175 rpm, furnishing the final ink.

Table 2 shows the conductive ink properties according to the present disclosure.

TABLE 2

| Property | Method | Result |
|---|---|---|
| Silver content | Ash | 65.06% |
| Volatiles content | TGA at 40 C. | 1.59% |
| Viscosity | shear sweep 4-400 s⁻¹ | 8.36 cps |

### Example 2

### Ink Sample with High Viscosity

52 g of a wetcake of stabilized Ag nanoparticles was loaded into a plastic bottle that contained 10 g of bicyclohexyl and 17 g of 5 mm glass beads. Then, the mixture was milled at a slow rate (˜200 rpm) for 18 hours on a roll-mill. Next, the glass beads were filtered out and the concentrate was then loaded into a vacuum oven at room temperature and evacuated for 30 hours. The resulting conductive silver nanoparticle ink contained a silver content of 76 wt %, which was determined by removing all the solvents and organic stabilizer at a hot plate (˜250° C.) for 20 minutes. The conductive silver ink according to this example has a viscosity of approximately 53 cps.

### K-Proof Printing and Flexi-Proof Printing

Approximately 5 mL of the ink of Example 1 was spread on the gravure plate of a K-printing proofer (RK Print Coat Instruments Ltd, UK) and K-proof prints were made on Xerox Digital Colour Elite Gloss (DCEG) coated paper and to a PET (polyethylene terepthalate, or Mylar) plastic substrate. The printed films were dark-blue black after printing, and gradually took on a silvery sheen after drying. The prints were dried in the oven at 130° C. for 30 minutes to complete the solvent evaporation and annealing process.

The same ink sample (Example 1) was also printed with a Flexi-proof printer (RK Printcoat Instruments, Royston, UK) and annealed at 130° C. for 30 minutes. Two coating weights were applied to each substrate (the anilox roll coating densities were 18 cm³/m² and 13 cm³/m² respectively).

### Sheet Resistance, Resistivity, and Conductivity Measurements

To measure the sheet resistance of the annealed samples, a 4-point probe was used. The average thickness of the coated films was determined by SEM—this value was used to calculate an approximate resistivity (in Ω·cm) from the measured sheet resistance by multiplying the sheet resistance by the film thickness (in cm). Finally, the conductivity is computed by taking the inverse of the resistivity. The sheet resistance is given by the following formula:

$$Sheet resistance [ \frac{\frac{Ω}{square}}{mil} ] = \frac{Resistance [ Ω ] * Thickness [ mils ]}{squares number [ dimensionless ]}$$

$$where \text{:}$$

$$Squares number = \frac{Length [ mm ]}{Width [ mm ]}$$

The resistivity is given by the following formula:

Resistivity=sheet resistance (in Ω/square)×thickness (in cm)

The conductivity is the reciprocal of resistivity:

Conductivity=1/resistivity

The lower the sheet resistance value, the better the conductivity. The goal is to minimize sheet resistance

Table 3 shows the results of the measured values for the sheet resistance, and calculated resistivity and conductivity for the coated films prepared from the ink described in Example 1 on coated paper and Mylar substrates. A-D are designations of the 4 different samples.

TABLE 3

| | | | Sheet | Approximate | | |
|---|---|---|---|---|---|---|
| | | | Resistance | Thickness | Resistivity | Conductivity |
| Sample | Substrate | Type of Print | (Ω/sq) | (μm) | (Ω-cm) | (S/cm) |
| A | Coated | K-proof | 1.67 | 0.5 | 1.67 × 10⁻⁴ | 3.58 × 10³ |
| B | Mylar | Flexi-proof | 0.46 | 0.8 | 3.7 × 10⁻⁶ | 2.7 × 10⁵ |
| C | Mylar | Flexi-proof | 0.80 | 0.8 | 6.4 × 10⁻⁶ | 1.5 × 10⁵ |
| D | Mylar | Flexi-proof | 0.90 | 0.5 | 4.5 × 10⁻⁶ | 2.2 × 10⁻⁵ |

### SEM Image Analysis

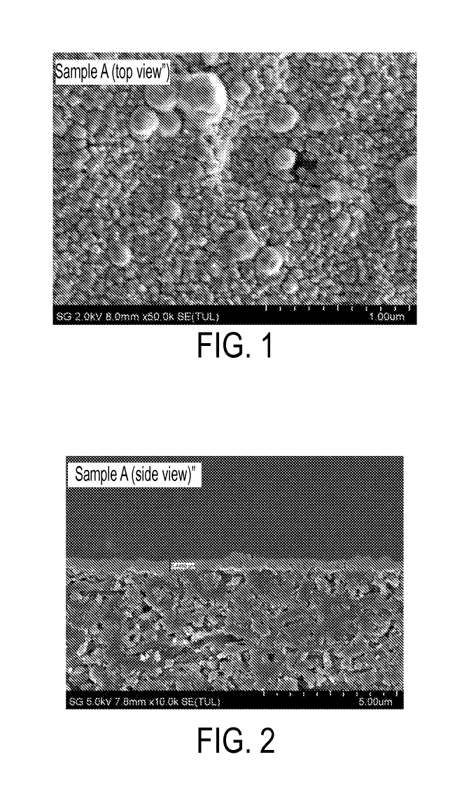

A section of each film of Example 1 was deposited on the different substrates and then examined under SEM (scanning electron microscopy) to observe each film topography. The images are shown in FIGS. 1 to 8. The thickness of the annealed silver film ranged from 0.5 to 0.8 μm.

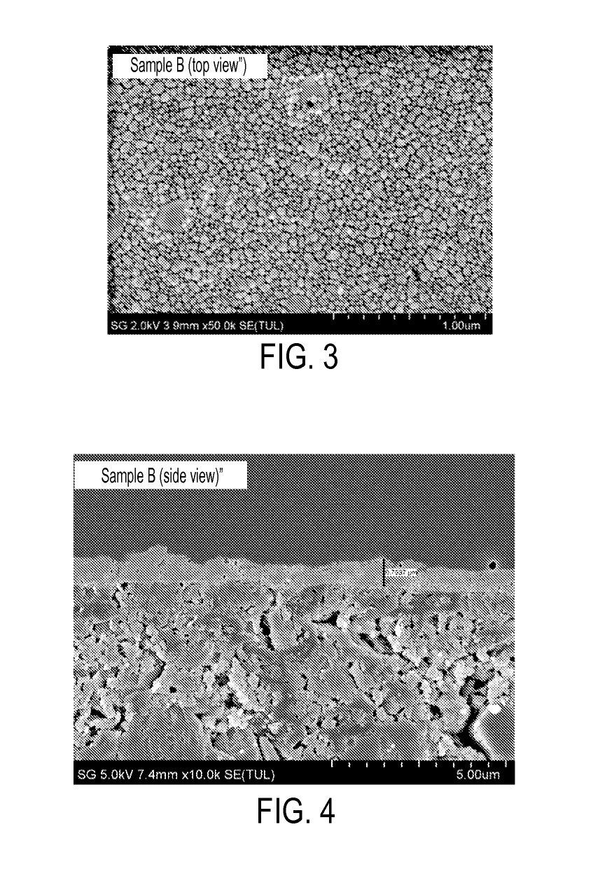

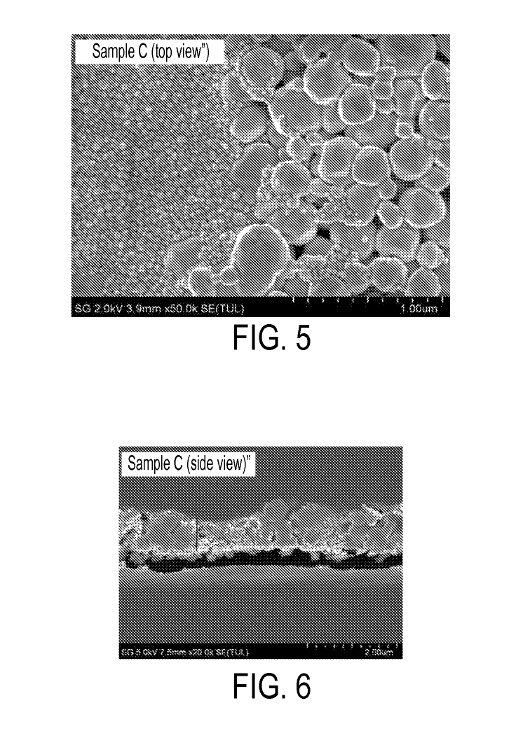

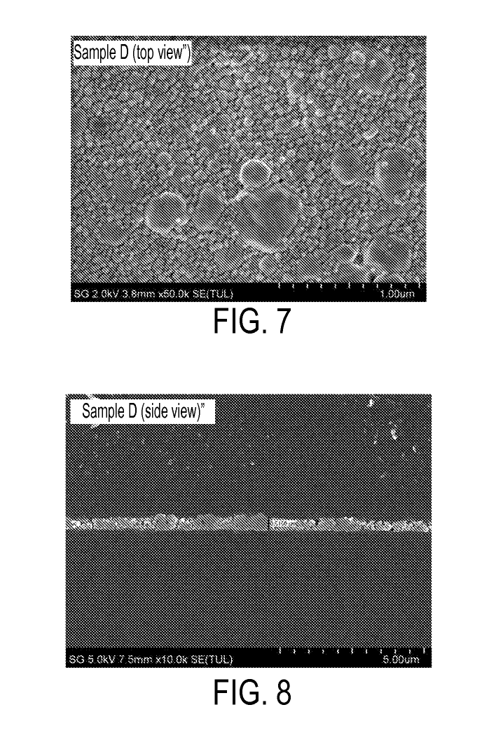

FIG. 1 illustrates a scanning electron microscope image (SEM image) of the top view of a cured ink film of Example 1 deposited onto a coated paper substrate (sample A). FIG. 2 illustrates an SEM cross-sectional view of the film of FIG. 1. FIG. 3 illustrates an SEM image of the top view of a cured ink film of Example 1 deposited onto a Mylar substrate (sample B). FIG. 4 illustrates an SEM cross-sectional side view of the film of FIG. 3. FIG. 5 illustrates an SEM image of the top view of a cured ink film of Example 1 deposited onto a Mylar substrate (sample C). FIG. 6 illustrates an SEM cross-sectional view of the film of FIG. 5. FIG. 7 illustrates an SEM image of the top view of a cured ink film of Example 1 deposited onto a Mylar substrate (sample D). FIG. 8 illustrates an SEM cross-sectional view of the film of FIG. 7.

As can be seen from FIGS. 3-8, the conductive ink according to the present disclosure has the ability to print on coated paper and substrates. This phenomenon is an advantage of flexography over gravure, which is usually preferred for porous substrates like paper and cardboard. Furthermore, flexography prints are generally thinner than gravure prints. Using nanoparticle silver ink with high conductivity at low pile heights is an enabler for using flexography for conductive ink printing.

It will be appreciated that variations of the above-disclosed and other features and functions, or alternatives thereof, may be desirably combined into many other different systems or applications. Also that various, presently unforeseen or unanticipated, alternatives, modifications, variations or improvements therein may be subsequently made by those skilled in the art which are also intended to be encompassed by the following claims.

1. A high silver content nanosilver conductive ink, comprising:
silver nanoparticles in an amount greater than 85 weight percent and up to 95 weight percent of the ink;
one or more non-polar organic solvents; and
an optional binder.

2. The conductive ink according to claim 1, wherein the silver nanoparticles have an average particle size of from about 0.5 to about 100.0 nm.

3. The conductive ink according to claim 1, wherein the silver nanoparticles have a spherical shape.

4. (canceled)

5. The conductive ink according to claim 1, wherein the silver nanoparticles are selected from the group consisting of elemental silver, a silver alloy, a silver compound, or combinations thereof.

6. A high silver content nanosilver conductive ink, comprising:
silver nanoparticles in an amount greater than 85 weight percent of the ink;
a solvent mixture consisting of decalin and bicyclohexyl; and
an optional binder.

7. The conductive ink according to claim 6, wherein the ink has a viscosity of from about 30 cps to about 750 cps.

8. The conductive ink according to claim 6, wherein ink has a sheet resistivity of less than about 2 Ω/sq.

9. (canceled)

10. (canceled)

11. (canceled)

12. The conductive ink according to claim 6, wherein the solvent comprises an amount of from about 5.0 to about 50.0 weight percent of the conductive ink.

13. A high silver content nanosilver conductive ink, comprising:
silver nanoparticles in an amount of 82 weight percent of the ink; and
a solvent mixture consisting of decalin and bicyclohexyl in a ratio of 7:1 by weight; and
an optional binder.

14. The conductive ink according to claim 13, wherein the ink has a conductivity of from about 1.0×10⁴ (S/cm) to about 4.0×10⁵ (S/cm).

15. The conductive ink according to claim 13, wherein the ink has a viscosity of from about 20 cps to about 1,000 cps.

16. The conductive ink according to claim 13, wherein the binder has a weight average molecular weight (Mw) of from about 10,000 to about 600,000 Da.

17. The conductive ink according to claim 13, wherein the binder comprises an amount of from about 0.25 weight percent to about 10 weight percent of the ink.

18. The conductive ink according to claim 13, wherein the binder has a viscosity of >10⁶ cps at room temperature.

19. The conductive ink according to claim 13, wherein the binder is selected from the group consisting of polyvinylbutyral (PVB) terpolymer, terephthalates, terpenes, styrene block, styrene-butadiene-styrene copolymer, styrene-isoprene-styrene copolymer, styrene-ethylene/butylene-styrene copolymer, styrene-ethylene/propylene copolymer, ethylene-vinyl acetate copolymers, ethylene-vinyl acetate-maleic anhydride terpolymers, ethylene butyl acrylate copolymer, ethylene-acrylic acid copolymer, polymethylmethacrylate, polyethylmethacrylate, poly(alkyl)methacrylates, polyolefins, polybutene, polyamides, and mixtures thereof.
